(19) United States
(12) Patent Application Publication
(10) Pub. No.: US 2014/0138508 A1
(43) Pub. Date: May 22, 2014

(54) Exercise Mat Hanging Mechanism

(71) Applicant: Digital Display Innovations, LLC, San Francisco, CA (US)

(72) Inventors: Arden Tyler Margulis, San Francisco, CA (US); Neal David Margulis, San Francisco, CA (US)

(73) Assignee: Digital Display Innovations, LLC, San Francisco, CA (US)

(21) Appl. No.: 13/678,563

(22) Filed: Nov. 16, 2012

(51) Int. Cl. F16M 13/02

(52) U.S. Cl. CPC F16M 13/02
USPC 248/317; 29/428

(57) ABSTRACT

A holder for securing and hanging an exercise mat in an unrolled position that allows the mat to be cleaned, dried and/or stored between uses. The holder has minimal impact on an exercise mat, and can work with a variety of sizes of mats without modifications. Various hanging and mounting configurations enable hanging a mat from a shower curtain, shower head, closet clothes bar, over a door, affixed to a wall or other similar structures.

### BACKGROUND

1. Field of the Invention

The present invention relates to storage and hangers for exercise mats.

2. Discussion of Prior Art

People use exercise mats when stretching or practicing yoga, Bikram or similar activities during which they perspire. Exercise mats are typically rectangular, range from an eighth of an inch to an inch thick, from 20″ to 32″ wide, and from 60″ to 96″ long, to approximate human proportions. Even when towels are used over them, exercise mats may still get wet from perspiration. Mats also require periodic washing and drying.

Options for storing mats between uses have been limited. Mats are often slung over a towel bar or “ballet bar,” or whatever else is available. Such expedients may not permit mats to lie flat and may instead crease or bend them. Mat surface areas contacting a towel bar may not receive enough air flow to dry quickly. There exist a variety of clothes hangers having clamps or levers designed for holding pants, skirts, and other clothes, such as U.S. Pat. No. 6,021,933 by Zuckerman. A typical clothes hanger is at most 18″ wide; pants-hanging clamps are closer together than that. While a clamping clothes hanger may hold thinner and lighter exercise mats, the clips' narrow spacing may cause the corners of the mat to fold over, which is less than ideal. Clips with narrower surface areas require intensified pressure on the exercise mat, which can damage or compromise the surface integrity of the mat or its cover. Hanging mats by straps may also fail to hang them fully unrolled. Other designs modify standard mats for hanging with rings, Velcro, magnets, etc. which may interfere with the intended use of, and undesirably compromise, an exercise mat.

Lacking a convenient way to store an exercise mat in its normal unrolled position, people typically roll mats up for transport and storage, and don't unroll them until the next use. Mats are thus stored damp and may not dry quickly. A rolled up and stored mat, when unrolled again tends not to initially lay in the desired flat position. Damp exercise mats that are not dried properly may build up undesirable bacteria, mold and odors.

There remains, therefore, a need for a technique of storing exercise mats in a position to dry in their normal flat shape.

### SUMMARY OF THE INVENTION

The above-described problems are relieved by the present invention providing a holder for hanging an exercise mat securely in its unrolled position, with minimal impact, and without requiring modifications, to the mat.

A preferred embodiment comprises a baseboard or mounting portion connected to a clip or securing portion, which together gently but firmly exert compression across the width of an exercise mat. The securing portion (“clip”) may consist of one or more clips, clamps or cams positioned along the width of the mat. A typical exercise mat is between 20″ and 32″ wide, and the securing portion will be of a similar, though not necessarily equal, width. In order not to damage exercise mats the clip has a broad surface that comes in contact with the mat. The contact surface(s) may have a non-slip texture provided by a surface material or by a directional material design. Additional portions of non-slip materials such as natural rubber may be used to enhance the holding of the mat and further reduce the pressure needed to hold a mat weighing up to about five pounds or up to nine pounds when wet. Force for the clip to hold the mat may be provided by the material design of the clip, by being spring loaded, by being gravity loaded, by using a levering mechanism, by using a cam or other means, or a combination of these means.

Once a mat is secured by the clip, various hanging solutions enable hanging the holder and mat from a shower curtain, shower head, clothes closet bar, door, wall, window, tiles, or other structure. When hung over a door or affixed to a wall, the hanging solution enables spacing the mat from the door or wall to permit air to flow along, and dry, both sides. The mat dries in its normal deployed shape and avoids being curled or cracked.

The hanging mechanism may be combined into a unit that has support for hanging a towel, a bag for the mat, or storing related items such as blocks, straps, water bottles, or cleaning products. The hanging mechanism can be used to hang similarly shaped exercise towels that may or may not include non-slip properties incorporated into the towel. The towel hanging may be in addition to the mat or instead of the mat.

These and other advantages of the invention will be illuminated by the following Detailed Description and accompanying Drawings.

### BRIEF DESCRIPTION OF THE DRAWING

FIG. 1 is a perspective view of the mat holder in a preferred first embodiment;

FIG. 2 is a front view of the mat holder in a second embodiment with hanging means including hooks;

FIG. 3 is a back view of the second embodiment;

FIG. 4 is a bottom view of the second embodiment;

FIG. 5 is a top view of the second embodiment;

FIG. 6 is a top view of the mat holder in a third embodiment having a single long hinge;

FIG. 7 is a view of the left side of the second embodiment with the jaws closed;

FIG. 8 is a left side view of the second embodiment with the jaws open;

FIG. 9 is a perspective view of the second embodiment;

FIG. 10 is a perspective view of the second embodiment hung over a door and suspending an exercise mat;

FIG. 11 is a perspective view of the first embodiment with hanging means including a wire, cord or string; and

FIG. 12 is a perspective view of a fourth embodiment having a taller baseboard and a clip handle without a tab section.

### DETAILED DESCRIPTION OF PREFERRED EMBODIMENTS

The present invention provides exercise mat holders which may be hung from walls, doors or other structures to store exercise mats in their unrolled position so that the mats will remain flat and if damp will dry properly.

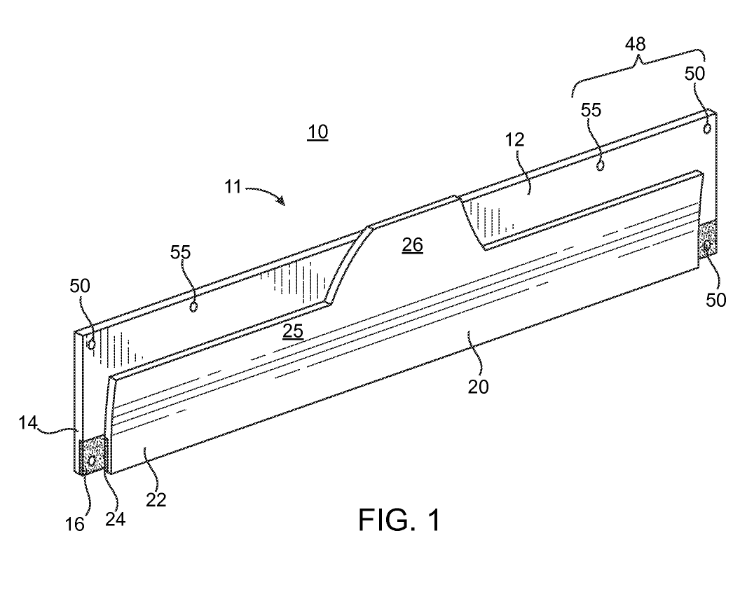

FIG. 1 shows mat holder 10 in a first preferred embodiment 11 comprising a baseboard 12 and a clip 20 which may be formed of a combination of wood, metal, plastics, polycarbonate, ABS, recycled PET, environment friendly resin, and/or similar materials.

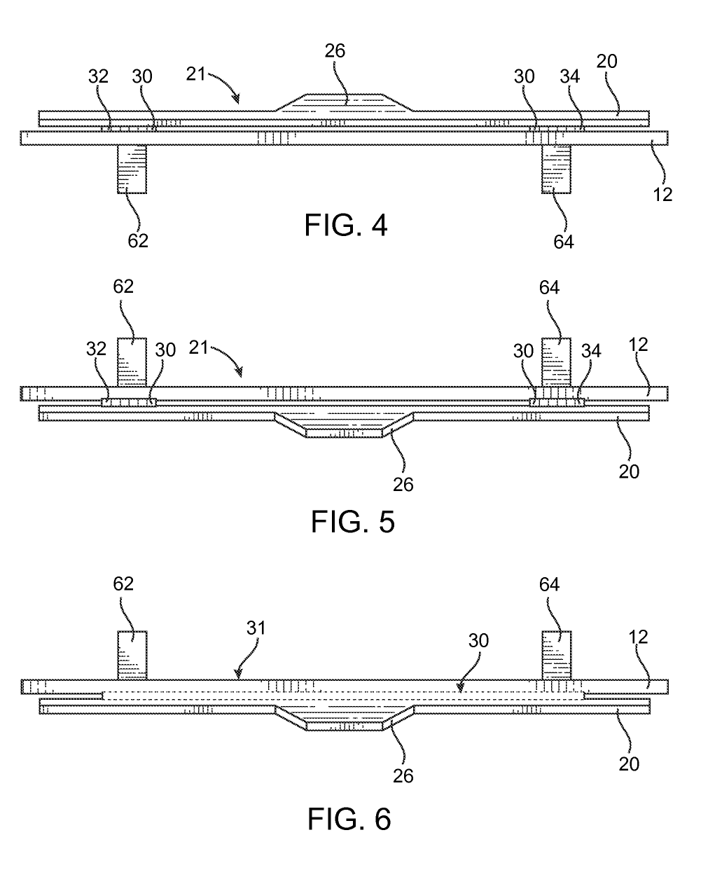

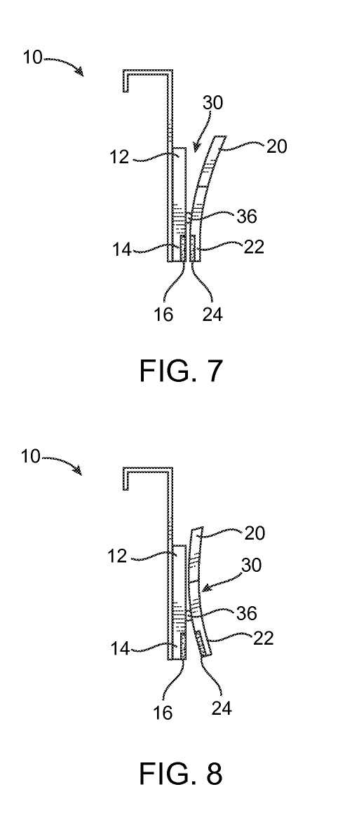

As shown in FIGS. 4-8, baseboard 12 and clip 20 are coupled by a hinge means 30 for pivotally connecting baseboard 12 to clip 20 and for elastically compressing their lower portions 14 and 22 together. The hinge means may take on any number of forms that allow a pivot or movement, in which the means for pivotally connecting and the means for elastically compressing may be the same or separate parts. The means for pivotally connecting may include an axle or concentric rings. The clip force may be provided by various mechanisms such as springs, clamps, cams, a gravity-loaded mechanism, or deformation of the clip or connecting material. In a second embodiment 21 shown in the bottom view of FIG. 4 and the top view of FIG. 5, hinge means 30 comprises left hinge 32 and right hinge 34, with a hinge axis 36 (FIGS. 7-9). Hinges 32, 34 preferably each includes a coiled steel spring (not shown) of a type as is used in well-known clothes pins, clip boards or hangers of various kinds, with compression and torsion springs being the most common.

Many clips have both sides the same and are symmetrical around their pivot axis. In contrast, the present invention's mat hanger is preferably non-symmetrical, having differently shaped base and clip portions. While symmetrical clips typically have the same external attachment capabilities from either side, mat hangers 10 according to the present invention preferably mount or hang from the base portion 12.

Dual hinges 32, 34 being spaced apart spreads pressure across a mat. In a third embodiment 31 as shown in FIG. 6 hinge means 30 comprises a single long hinge. The clip force may be distributed more evenly by for example the use of flexures, additional hinges, clip springs distributed across the width of the clip, centered clip springs with wider hinges, a pressure clamp with centered or distributed force using a flexure(s), or a gravity-based clamp in which the weight of a mat determines the force applied.

A cam-based holding mechanism having a cam parallel to a baseboard, or having a parallel pair of cams, can allow a mat to slide easily in between the cam(s), and then lock the mat in place. A cam-based exercise mat holder could comprise a baseboard with clamping cam means including an elongated cam having lengthwise ends mounted on the baseboard. The cam has a radius varying such that turning the cam (by moving a mat down between the cam and the baseboard) decreases spacing between the cam and the baseboard and compresses the mat. A cam mechanism that is less wide than a mat allows a user to hold the sides of a mat and slide it up past the cams. Cams may use a spring or a lever to engage a mat, and the mat's weight will help hold it. A mat can be released by moving the mat upwards briefly to release the cam or by manually turning the cam directly or via a knob or lever.

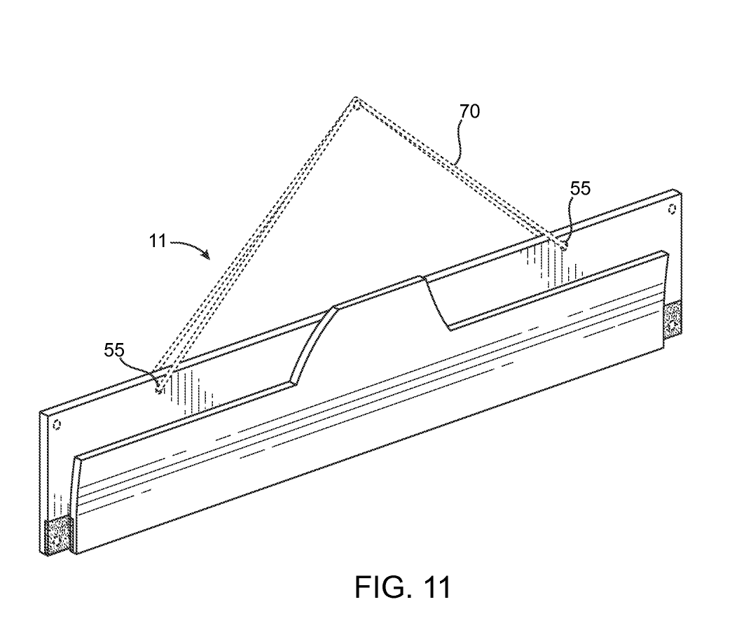

As shown in FIG. 1 holder 10 comprises hanging means 48 preferably including, in baseboard 12, mounting holes 50 and/or bracket attachment holes 55 through which pegs, nails, screws, bolts, or other fasteners may be passed to hang baseboard 12 directly on a door 202 or a wall. Alternatively, holes 50, 55 may be threaded with a string, cord or wire 70 as shown in FIG. 11 to hang baseboard 12 from an external support such as a peg or hook.

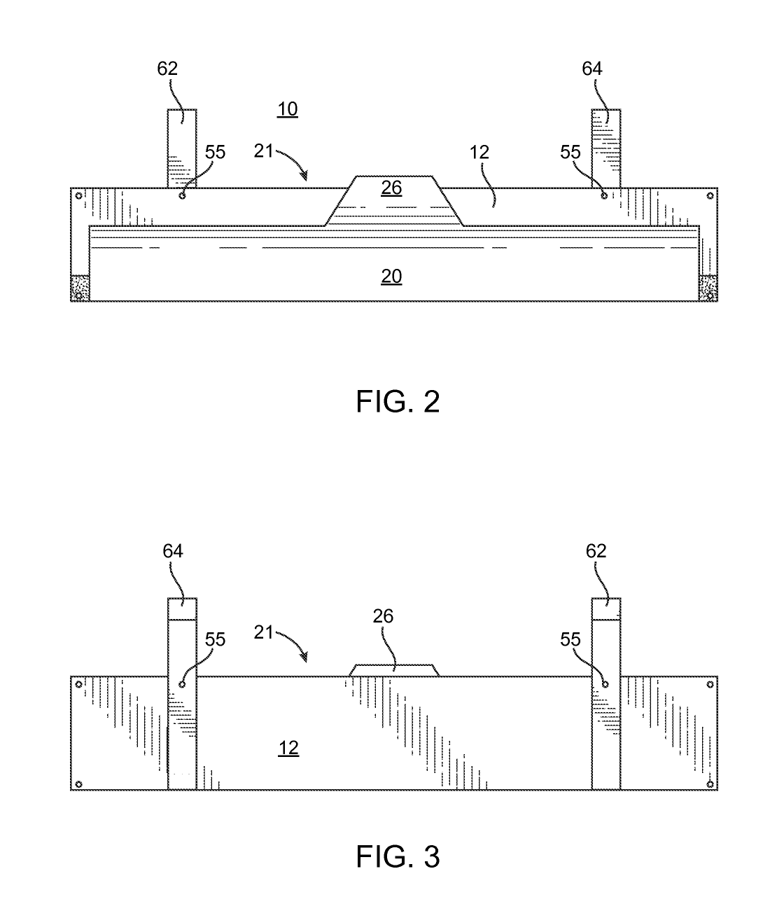

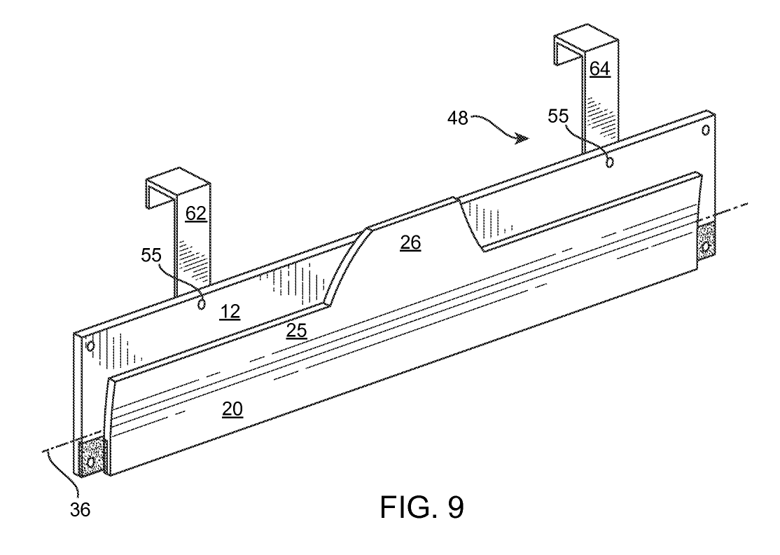

In conjunction with, or instead of, using mounting holes 50, bracket attachment holes 55 may be used for attaching hooks 62, 64 as in the preferred second embodiment 21 shown in FIGS. 2-5 and 7-10. FIG. 9 shows hanging means 48 including hooks 62, 64 attached to baseboard 12 by, for example, mating nubs (not visible) that snap permanently or removably into bracket holes 55. Hooks 62, 64 may also be cemented to, or molded in a single piece with, baseboard 12. FIG. 3 is a rear view of the holder 10 showing hook brackets 62, 64 spanning the full height of baseboard 12, though other heights may be used. Additionally, hook brackets may be of other configurations such as a single hook for use on a clothes closet rod. Other hanging means such as suction cups may be used to affix baseboard 12 to a window, shower door or tiled wall.

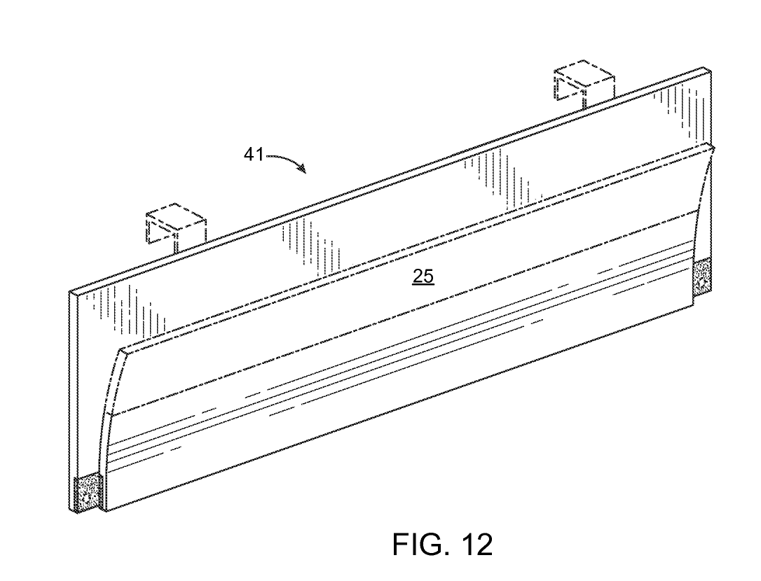

To provide leverage for opening clip 20, handle 25 may extend upward into a tab section 26 as in the second embodiment 21 and third embodiment 31. A clip design may include one, two, three or more handle pressure positions to leverage open the clip. Additionally, a clip can be designed such that its full length can be levered as a handle. FIG. 12 shows a fourth embodiment 41 having a taller baseboard 12 and a taller handle 25 instead of a tab section. Some clamping, cam, lever or gravity loaded mechanisms may use different forms of handle or no handle.

Below hinge axis 36 the lower portions of baseboard 12 and clip 20 form compression portions or jaws 14 and 22 having broad areas and rounded corners for contacting a mat without damaging it. As shown in FIGS. 1 and 7-9, at least part of jaws 14 and 22 preferably have non-slip gripping surfaces 16 and/or 24 to help grip mats with minimized pressure from clip 20. As shown in the FIGS. 7 and 8 side views, clip jaw 22 is curved concave outward to present a rounded area, instead of a sharp corner, in contact with a mat. The gripping surface 16, 24 may derive friction from texturing with the same or a different material than the clip and baseboard. Materials such as soft rubber or cork are examples of non-slip surfaces.

Hinge means 30 biases jaws 14 and 22 together. When holder 10 is not holding a mat, jaws 14 and 22 close to their at-rest position as shown in FIG. 7. Pressing clip handle 25 toward baseboard 12 spreads jaws 14 and 22 apart as shown in FIG. 8 to release or admit an edge of a mat.

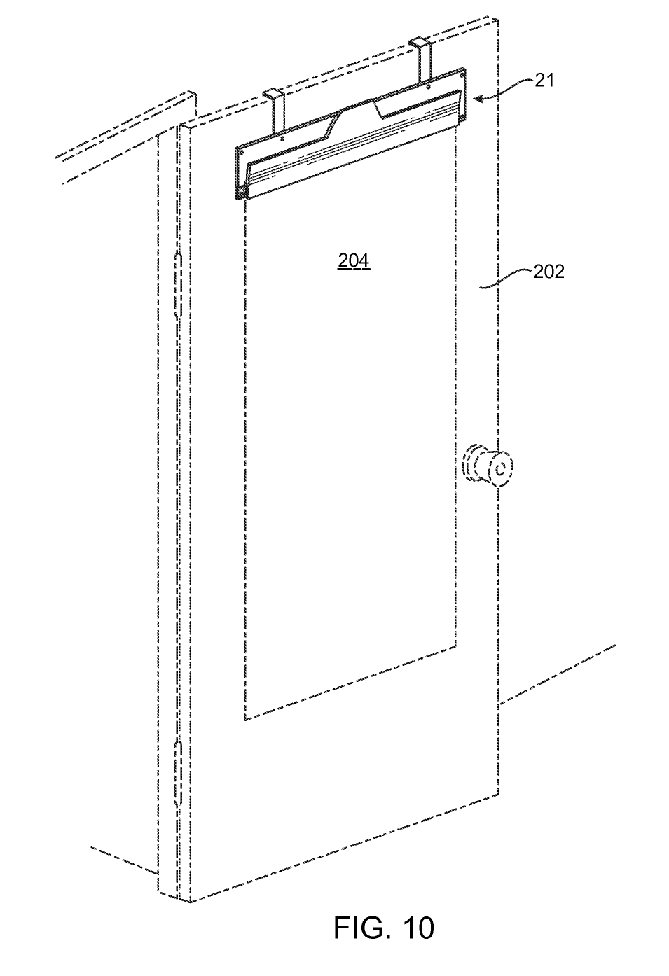

FIG. 10 shows mat holder 10 in use with a mat 204 inserted under clip 20 and supported by a door 202. A user presses handle 25 to spread jaws 14 and 22, inserts an (e.g. the shorter) edge of a mat, and releases the clip. Holder 10 may be hung over a door 202 or other support before or after a mat 204 is inserted. The mat will hang straight and flat, and dry properly. Mat holder 10 positions a mat 204 close enough to a door 202 that the door may still be used normally. At the same time, baseboard 12 is preferably thick enough to leave space for air to circulate between the mat and a door so that both sides of the mat can dry readily.

Though baseboard 12 is shown as a single unit it may be manufactured as two halves that are joined to form a baseboard of the desired width. The two halves may be different right and left halves, or they may be identical parts and flipped or rotated to be used as either the left or right side. The two halves could be snapped, glued, or screwed together, or joined some other way. A primary motivation for producing a baseboard in two halves would be to reduce the cost of fabricating a larger single baseboard.

Similarly, the clip 20 may be split into two or more portions and distributed across the baseboard 12 such that a mat 204 hangs supported and unrolled. If the clip is split, each clip may have one or more handle portions for leveraging it open. It is also possible for the clip to be split and for split clips to have their own compression mechanisms, with one handle portion extending across the clips.

While the present invention is described in terms of several preferred embodiments, it will be appreciated by those skilled in the art that these embodiments may be modified without departing from the essence of the invention. It is therefore intended that the following claims be interpreted as covering any modifications falling within the true spirit and scope of the invention.

1. An exercise mat holder comprising:
a baseboard having a long width and a shorter height;
a single piece clip having a width approximately equal to the width of the baseboard, and
including a jaw portion having a broad contact area below a hinge axis, and
a handle portion above the hinge axis,
said baseboard and said clip not being symmetrical about said hinge axis;
hinge means for pivotally coupling the clip to the baseboard, and
for elastically compressing the jaw portion towards the baseboard; and
hanging means for hanging the baseboard from a support.

2. (canceled)

3. The holder of claim 1 wherein the hinge means comprises a single hinge extending substantially across the width of the clip.

4. (canceled)

5. (canceled)

6. The holder of claim 1 wherein the hanging means comprises hooks attached to the baseboard.

7. The holder of claim 1 wherein the hanging means comprises holes through the baseboard through which string may be threaded.

8. The holder of claim 1 wherein a compression portion of at least one of the baseboard and of the clip has an enhanced friction gripping surface.

9. The holder of claim 1 wherein the clip is curved concave outward from the baseboard.

10. The holder of claim 1 wherein the hinge means is capable of exerting sufficient force to hold a wet exercise mat.

11. An exercise mat holder, comprising:
a baseboard including hanging means and having a thickness sufficient to space a mat from a wall;
a single piece clip having a width across which an upper portion forms a handle and a lower portion forms a jaw with a broad contact area;
pivot means for rotatably connecting the clip to the baseboard so that rotating the clip to move the handle towards the baseboard moves the jaw from the baseboard; and
spring means for urging the jaw towards the baseboard.

12. The holder of claim 11 wherein the hanging means comprises hooks attached to the baseboard.

13. The holder of claim 11 wherein the hanging means comprises holes in the baseboard through which string may be threaded.

14. The holder of claim 11 wherein a compression portion of at least one of the baseboard and of the clip has an enhanced friction gripping surface.

15. The holder of claim 11 wherein the clip is curved concave outward from the baseboard.

16. The holder of claim 11 wherein the spring means is capable of exerting sufficient force to hold a wet exercise mat.

17. A method of forming an exercise mat holder, comprising:
providing a baseboard having a width, a height, and, below a hinge line midway up its height across its width, a compression portion;
providing a clip having a width and a height approximately equal to, but not symmetrical with, those of the baseboard and, below a hinge line, a jaw portion with a broad contact area;
providing hinge means including
pivot means for pivotally connecting said baseboard and said clip together so that said compression portion and said jaw portion can rotate from being adjacent to being far enough apart to admit an exercise mat, and
spring means for biasing said compression portion and said jaw portion together with a force adequate to hold an exercise mat;
connecting said baseboard and said clip together with said pivot means; and
providing means for hanging said baseboard from an external support.

18. A method as in claim 17 wherein the baseboard has a thickness which will space a mat from a wall supporting the baseboard far enough for the mat to dry readily.

19. A method as in claim 17 wherein the pivot means comprises at least one hinge.

20. A method as in claim 17 wherein the broad contact area has non-sharp corners and a non-slip surface.
